(19) United States
(12) Patent Application Publication
(10) Pub. No.: US 2012/0237639 A1
(43) Pub. Date: Sep. 20, 2012

(54) MEAL SUBSTITUTE IN FORM OF BREAD TYPE COOKED FOOD AND A SPREAD TYPE CONDIMENT

(75) Inventor: Jean-Marie Blanchet, Lutzelhouse (FR)

(73) Assignee: ET & DS COMPANY LTD., Limassol (CY)

(21) Appl. No.: 13/500,772

(22) PCT Filed: Oct. 25, 2010
(86) PCT No.: PCT/FR2010/052279

§ 371 Date: May 22, 2012

(30) Foreign Application Priority Data
Oct. 26, 2009 (EP) 09306012.7

(51) Int. Cl. A21D 13/00; A23L 1/221; A21D 2/02; A21D 8/06; A21D 13/08; A21D 2/08

(52) U.S. Cl. 426/73; 426/549; 426/551; 426/72; 426/243

(57) ABSTRACT

A meal substitute containing nutrients including energetic and nutritional intake. Said meal substitute takes the form of a combination of bread- or cake-type food to be cooked and a spread- or cream-type condiment obtained from two separate powder mixtures to be mixed with water. The components of the mixture for manufacturing the food to be cooked are provided so as to obtain bread or cake after cooking for 2.5 to 6 minutes in a microwave oven, and the components of the mixture are provided so as to obtain the spread or the cream including cooking-sensitive micronutrients.

Meal substitutes are intended to replace a full meal by providing essential nutrients so as to cover the whole of the nutritional needs of persons following a hypocaloric diet according to the regulations in effect. The present invention relates to a meal substitute for controlling weight which may be made quasi-instantaneously from powder mixed with water, in order to obtain a meal appearing in a standard form of bread slices or sandwiches. In most meal substitutes presently known, a powder is mixed with water in order to obtain a sweet or salty liquid foodstuff to be consumed cold or after having been warmed up. The substitute therefore does not assume the form of a solid meal, requiring chewing of the food, which gives the consumer the sensation of eating and not only drinking. In other words, the most widespread present substitutes form a double break relative to normal meals, because they specifically establish ingested nutritional and energetic intakes on the one hand, and on the other hand because they replace a meal with a drink and consequently break the traditional ritual of meals and more generally of human feeding modes which naturally prefer an approach based on the taste and texture of the foodstuffs, including different dishes or food products taken in succession.

The present invention is a meal substitute in solid form which forces the consumer to chew. This has two benefits: (i) the first benefit is that chewing is perceived by the nerve centers which control food intake. Chewing increases the feeling of satiety and limits food intake, which facilitates regularity with the diet for losing weight, (ii) the second benefit is that the solid meal substitute replaces the foodstuff which it forms in a more conventional meal logic, furthermore proposing in one of the proposed configurations a food base considered as quite essential at least in western cultures: bread. With the proposed product, it is possible to preserve the pleasure and habit of a conventional meal based on bread or equivalent while being hypocaloric and forming a sufficient and balanced content, i.e. it actually has the traditional profile of a meal substitute for replacing a wholesome meal.

Obviuosly, it is designed in order to include the whole of the energetic and nutritional intakes, and is characterized—as mentioned and mainly—in that it appears in the form of a combination of a foodstuff to be baked of the bread or cake type and of a accompanying foodstuff of the spread or cream type obtained from two distinct powdered mixtures to be mixed with water, the components of the mixture for making the foodstuff to be baked being provided for obtaining bread or cake after baking for 2.5 to 6 minutes in a microwave oven, and the components of the mixture for obtaining the spread or the cream including cooking-sensitive micronutrients. In particular, bread may appear in diverse forms, for example as a ball-shaped loaf or a flat loaf, the baking time may be different depending on said shape.

Mixing both powders with water leads to the obtaining of two different pasty products, one of which is subject to fast baking in order to end up with a solid texture for the basis of the meal, which may then be cut into slices or into portions on which is positioned the second pasty or liquid mixture, either sweet or salted according to the meal and to the taste of the user.

Both powder mixtures are, of course, packaged separately. In the following, the invention will be described on the basis of the preferential example consisting of bread and of spread, although other equivalent forms of the invention, such as for example cakes with cream, notably chocolate cakes with custard, may be applied.

This form of meal substitute allows the consumers to retain a usual type of food intake, for example by keeping the same consumption mode at breakfast, with bread slices with jam. The spread according to the invention will then be designed so as to assume the aspect of a jam. Another form of the invention may for example replace the habit which persons in a hurry have, of having a sandwich snack instead of lunch, with a meal substitute made from bread slices with a vegetable spread.

Not heating or not cooking a portion of the meal substitute according to the invention is essential in so far that this allows cooking-sensitive elements to be allocated to the powder mixture intended to produce the spread and to thereby guarantee the integrity of certain important micronutrients of the meal substitute, i.e. preserve their own characteristics and properties. The distribution of the components of the food substitute of the invention between the bread and the spread is notably effected according to this criterion.

Another criterion to be taken into account for allocating the components to each other, being aware that together, they should contain all the elements required for receiving the name of food substitute in the light of regulatory requirements, concerns the making of bread, and therefore of the other powder mixture: the bread should be able to be consumed at the end of a baking time as short as possible, not exceeding a few minutes.

The particular combination of the ingredients of the first powder mixture were specially studied and adapted in order to obtain a quickly baked bread. Indeed, with the combination of ingredients and the preparation method, preparation and baking are 10 times to 20 times faster than that for a traditional bread baked in an electric oven or with a bread-making machine.

In order to give the bread a good consistency and a good organoleptic property, the powder mixture for making the bread comprises at least the following ingredients:
wheat flour,
proteins,
vegetable oil,
fibers,
starch,
salt,
sodium pyrophosphate,
sodium bicarbonate,
BREAD flavor.

More specifically, the preceding composition may comprise the following ingredients:
wheat flour,
soya protein isolate,
soya bean oil,
milk proteins,
acacia fibers and wheat fibers,
manioc starch,
salt,
sodium pyrophosphate,
sodium bicarbonate,
BREAD flavor.

Still more specifically, it was seen after tests that in order to have very good consistency and texture, the proportions of the powder mixture for making the bread should be the following, for 100 g of powder:
36 to 78 g of wheat flour,
14 to 34 g of soya bean protein isolate,
3 to 8 g of soya bean oil,
2 to 6 g of milk protein,
1 to 5 g of acacia fibers and wheat fibers,
0.5 to 2 g of manioc starch,
0.3 to 0.9 g of salt,
0.35 to 0.9 g of sodium pyrophosphate,
0.2 to 0.55 g of sodium bicarbonate,
0.26 to 0.4 g of BREAD flavor.

And in a preferred embodiment of the invention, the powder mixture for making the bread will contain the following amounts, always for 100 g:
60.350 g of wheat flour,
23.871 g of soya bean protein isolate,
5.125 g of soya bean oil,
4.375 g of concentrated milk protein,
3.000 g of acacia fibers and wheat fibers,
1.250 g of manioc starch,
0.625 g of salt,
0.625 g of sodium pyrophosphate,
0.375 g of sodium bicarbonate,
0.325 g of BREAD flavor

Moreover, it is possible to integrate into the present bread at least one of the following ingredients and their mixture: guarana, royal jelly, acerola and/or an enzyme preparation so as to provide added value to the product.

Guarana promotes destocking of fats and has a significant energizing effect for maintaining dynamism during a slimming diet. Royal jelly is a natural source of micronutrients and contains natural antibiotic substances which reinforce the immune system. Acerola is a natural source of vitamin C. Finally, the enzyme complex allows facilitated digestion of the meal substitute, the richness of which in proteins and in complex sugars slows down gastric emptying.

These complementary components are added according to weight proportions of the order of 0.05 g to 0.3 g for 100 g of powder.

The second powder mixture for making the spread, also diluted in water, does not undergo any cooking step, by which, as mentioned, it is possible to guarantee the integrity of the cooking-sensitive micronutrients. This powder comprises elements such as vitamins, minerals, components providing their flavor to the spread, such as vegetables, fruit, chocolate, flavors as well as carbohydrates and additives.

The vitamins and minerals are used as a common base for the sweet and salted preparations of the accompaniment.

The difference between sweet and salted accompaniments comes from the respective proportions of the mixed vegetables, fruit, flavors and additives, as well as from the dosage of the chocolate.

According to one possibility, notably validated by taste and texture tests, the relative proportions of these elements in the powder mixture for making the spread may be selected for—100 g—, equal to:
49 to 88 g of vegetable, fruit, chocolate, carbohydrates, flavors and additives,
0.15 to 0.35 g of vitamins,
10.5 to 25 g of minerals.

More specifically, 100 g of powder mixture for making the spread consist of:
0.239 g of vitamins,
18.04 g of minerals,
81.71 g of vegetables, fruit, chocolate, carbohydrates, flavors and additives.

As regards minerals, they are provided by the following compounds: tripotassium citrate, anhydrous monocalcium phosphate, magnesium carbonate, tricalcium phosphate, iron sulfate III, zinc citrate, manganese gluconate, copper sulfate, potassium iodide, and sodium selenite. However they may be replaced with other equivalent mineral substances.

Like for the vitamins, the body needs of these minerals are not identical from one mineral to the other. According to the invention, the meal substitute provides the minerals according to the following amounts, for 100 g of the powder mixture producing the spread:
7.5 to 12.5 g of tripotassium citrate,
3 to 5 g of anhydrous monocalcium phosphate,
2 to 3.4 g of magnesium carbonate,
0.45 to 0.8 g of tricalcium phosphate,
0.09 to 0.15 g of iron sulfate III,
0.05 to 0.09 of zinc citrate,
0.02 to 0.0375 g of manganese gluconate,
0.005 to 0.009 g of copper sulfate,
0.00028 to 0.0005 g of potassium iodide,
0.000175 to 0.0003 g of sodium selenite.

And in a preferred embodiment of the invention, the spread contains the following amounts of minerals, always for 100 g:
10.250 g of tripotassium citrate,
4.225 g of anhydrous monocalcium phosphate,
2.718 g of magnesium carbonate,
0.625 g of tricalcium phosphate,
0.120 g of iron sulfate III.
0.072 g of zinc citrate,
0.03075 g of manganese gluconate,
0.00737 g of copper sulfate,
0.000375 g of potassium iodide,
0.000237 g of sodium selenite.

According to the invention, the powder mixture for making the spread comprises at least the following vitamins:
ascorbic acid,
vitamin E,
nicotinamide,
vitamin A acetate,
vitamin B5,
vitamin D3,
vitamin B6,
vitamin B2,
vitamin B1,
vitamin B9,
biotin
vitamin B12.

Vitamin needs are not identical. Indeed, certain overdoses of vitamins are dangerous for the person. Consequently, the provision of vitamins is made, for 100 g, according to the following amounts:
0.06 to 0.135 g of ascorbic acid,
0.04 to 0.09 g of vitamin E and its derivatives,
0.02 to 0.045 g of nicotinamide and its derivatives,
0.01 to 0.024 g of vitamin A and its derivatives,
0.008 to 0.019 g of vitamin B5 and its derivatives,
0.0025 to 0.006 g of vitamin D3 and its derivatives,
0.002 to 0.005 g of vitamin B6 and its derivatives,
0.0017 to 0.004 g of vitamin B2 and its derivatives,
0.0017 to 0.004 g of vitamin B1 and its derivatives,
0.00027 to 0.00006 g of vitamin B9 and its derivatives,
0.00006 to 0.00015 g of biotin and its derivatives,
0.000003 to 0.000007 g of vitamin B12 and its derivatives.

In a preferred embodiment of the invention, the spread contains the following amounts of vitamins:
0.09633 g of ascorbic acid,
0.06505 g of vitamin E and its derivatives,
0.03315 g of nicotinamide and its derivatives,
0.01694 g of vitamin A and its derivatives,
0.01355 g of vitamin B5 and its derivatives,
0.00413 g of vitamin D3 and its derivatives,
0.00349 g of vitamin B6 and its derivatives,
0.002915 g of vitamin B2 and its derivatives,
0.002877 g of vitamin B1 and its derivatives,
0.000454 g of vitamin B9 and its derivatives,
0.000104 g of biotin and its derivatives,
0.000005 g of vitamin B12 and its derivatives.

Vegetables, fruits, seasoning or flavors may also be added to the composition. According to possibilities specific to the invention, the spreads may be based on at least one of the following ingredients, or their combination:
tomato powder, zucchini flakes, acacia fibres or grilled onion powder, green olives in pieces, carrot powder or celery powder, when the spread is salty;
strawberry powder, raspberry powder, blueberry powder, beetroot coloring agent, strawberry flavor, raspberry flavor, blackberry flavor or dextrose for a sweet spread.

However, other components may naturally be used, such as for example chocolate.

According to one possibility, the meal substitute of the invention in fact contains the following components:
Tripotassium citrate
Anhydrous monocalcium phosphate
Magnesium carbonate
Tricalcium phosphate
Iron sulfate III
Ascorbic acid
Zinc citrate
Vitamin E
Nicotinamide
Manganese gluconate
Vitamin A
Vitamin B5
Copper sulfate
Vitamin D3
Vitamin B6
Vitamin B2
Vitamin B1
Vitamin B9
Potassium iodide
Sodium selenite
Biotin
Vitamin B12.

This meal substitute is obtained in a particular way in two steps. In the example of the bread and of the spread, the first step consists of making the bread in the following way:
pour 48 g of the powder allowing the bread to be made into a container;
add 60 ml of water;
mix the obtained dough until a ball-shaped loaf, a flat loaf or any other shape is formed;
place the prepared form in a micro-wave oven;
bake it for 2.5 to 6 mins at 750 W.

These are amounts given as an example and which are based on the existence of a dose of 48 g of the first powder mixture as available commercially, as this will also be the case for the example below concerning the second mixture.

Moreover, it is possible to place an at least partly filled glass of water in the vicinity of said prepared form.

In a second phase, the consumer prepares the spread, according to the following steps:
pour 45 ml of cold water into a container,
gradually add 16 g of the second powder mixture while stirring in order to obtain a homogeneous paste.

Next, the consumer deposits the sweet or salted accompaniment on the bread as if he/she was making a slice of bread or a sandwich in order to prepare his/her meal.

According to a first example according to the invention, the composition intended for making the ball-shaped bread loaf contains:

| Ingredients | g/100 g of powder | g/reconstituted portion |
|---|---|---|
| Wheat flour type 45 | 60.350 | 28.968 |
| Soya bean protein isolate | 23.871 | 11.458 |
| Soya bean oil | 5.125 | 2.46 |
| Concentrated milk protein | 4.375 | 2.1 |
| Acacia fibers and wheat | 3.000 | 1.44 |
| Manioc starch | 1.250 | 0.6 |
| Salt | 0.625 | 0.3 |
| Sodium pyrophosphate | 0.625 | 0.3 |
| Sodium bicarbonate | 0.375 | 0.18 |
| Bread flavor | 0.325 | 0.156 |
| 12% guarana | 0.058 | 0.02784 |
| Freeze-dried royal jelly | 0.019 | 0.00912 |
| Enzyme preparation | 0.002 | 0.00096 |

The composition of a salty accompaniment may then be made with the following ingredients and amounts:

| | g/100 g of | g/reconstituted |
|---|---|---|
| Ingredients | powder | portion |
| Tomato powder | 28.75 | 4.6 |
| Zucchini flakes | 18.75 | 3 |
| Acacia fibers | 10.498 | 1.68 |
| Tripotassium citrate | 10.250 | 1.640 |
| Grilled onion powder | 10 | 1.6 |
| Anhydrous monocalcium | 4.225 | 0.6760144 |
| Green olives in pieces | 3.125 | 0.5 |
| Magnesium carbonate | 2.718 | 0.43500928 |
| Guar gum | 1.875 | 0.3 |
| Soya bean oil | 1.25 | 0.2 |
| Dextrose | 1.25 | 0.2 |
| Natural basil flavor | 1.25 | 0.2 |
| Salt | 1.094 | 0.175 |
| Xanthan gum | 1 | 0.16 |
| Carrot powder | 1 | 0.16 |
| Tricalcium phosphate | 0.625 | 0.10000208 |
| Broth flavor | 0.625 | 0.1 |
| Tomato-basil-garlic seasoning | 0.469 | 0.075 |
| Acerola with 25% Vitamin C | 0.279 | 0.045 |
| Maltodextrin | 0.209 | 0.033 |
| Celery powder | 0.125 | 0.02 |
| Iron sulfate III | 0.12 | 0.01920048 |
| 99% ascorbic acid | 0.09633 | 0.0154128 |
| Ground grey pepper | 0.094 | 0.015 |
| Zinc citrate | 0.07213 | 0.01154016 |
| Ground oregano | 0.069 | 0.011 |
| 38.10% vitamin E | 0.06505 | 0.01040864 |
| 99.7% nicotinamide | 0.03315 | 0.00530448 |
| Magnesium gluconate | 0.03075 | 0.00492 |
| 9.75% vitamin A acetate | 0.01694 | 0.00271024 |
| 91.6% vitamin B5 | 0.01355 | 0.00216784 |
| Copper sulfate | 0.007376 | 0.00118016 |
| 0.25% vitamin D3 | 0.004128 | 0.00066048 |
| 82.8% vitamin B6 | 0.00349 | 0.0005584 |
| 99.20% vitamin B2 | 0.002915 | 0.0004664 |
| 78.98% vitamin B1 | 0.002877 | 0.00046032 |
| 91.15% vitamin B9 | 0.000454 | 0.00007264 |
| Potassium iodide | 0.000375 | 0.00006 |
| Sodium selenite | 0.000237 | 0.00003792 |
| 99.4% biotin | 0.000104 | 0.00001664 |
| 97% vitamin B12 | 0.000005 | 0.0000008 |

Assuming a sweet accompaniment, and according to an example applied according to the invention, the composition may be the following:

| | g/100 g of | g/reconstituted |
|---|---|---|
| Ingredients | powder | portion |
| Dextrose | 25.524 | 3.444 |
| Maltodextrin | 10.932 | 1.749 |
| Tripotassium citrate | 10.250 | 1.640 |
| Manioc starch | 9.383 | 1.501 |
| Strawberry powder | 9.25 | 1.48 |
| Concentrated milk protein | 6.25 | 1 |
| Chicoree inulin | 4.888 | 0.782 |
| Anhydrous monocalcium | 4.225 | 0.6760144 |
| Guar gum | 3.75 | 0.6 |
| Beetroot coloring agent | 3 | 0.48 |
| Strawberry flavor | 3 | 0.48 |
| Raspberry flavor | 3 | 0.48 |
| Magnesium carbonate | 2.718 | 0.43500928 |
| Citric acid | 2.5 | 0.4 |
| Mineral flavor masking | 1.375 | 0.22 |
| Raspberry powder | 0.75 | 0.12 |
| Tricalcium phosphate | 0.625 | 0.10000208 |
| Xanthan gum | 0.625 | 0.1 |
| Blackberry flavor | 0.375 | 0.06 |
| Caramelized sugar | 0.363 | 0.058 |
| Acerola with 25% vitamin C | 0.279 | 0.045 |
| 1% Beta-carotene | 0.213 | 0.034 |
| Blueberry powder | 0.125 | 0.02 |
| Iron sulfate III | 0.12 | 0.01920048 |
| 99% ascorbic acid | 0.09633 | 0.0154128 |
| Acesulfame K | 0.075 | 3.444 |
| Zinc citrate | 0.07213 | 0.01154016 |
| 38.10% vitamin E | 0.06505 | 0.01040864 |
| Sucralose | 0.056 | 2.888 |
| 99.7% nicotinamide | 0.03315 | 0.00530448 |
| Manganese gluconate | 0.03075 | 0.00492 |
| 9.75% vitamin A acetate | 0.01694 | 0.00271024 |
| 91.6% vitamin B5 | 0.01355 | 0.00216784 |
| Copper sulfate | 0.007376 | 0.00118016 |
| 0.25% vitamin D3 | 0.004128 | 0.00066048 |
| 82.8% vitamin B6 | 0.00349 | 0.0005584 |
| 99.20% vitamin B2 | 0.02915 | 0.0004664 |
| 78.87% vitamin B1 | 0.002877 | 0.00046032 |
| 91.15% vitamin B9 | 0.000454 | 0.00007264 |
| Potassium iodide | 0.000375 | 0.00006 |
| Sodium selenite | 0.000237 | 0.00003792 |
| 99.40% biotin | 0.000104 | 0.00001664 |
| 97% vitamin B12 | 0.000005 | 0.0000008 |

1. A meal substitute integrating nutrients including the whole of the energetic and nutritional intakes, wherein it appears as a combination of a foodstuff to be baked of the type bread or cake and of an accompaniment foodstuff of the spread or cream type obtained from two distinct powder mixtures to be mixed with water, the components of the mixture for making the foodstuff to be cooked being provided for obtaining bread or cake after baking for 2.5 to 6 minutes in a microwave oven, and the components of the mixture for obtaining the spread or the cream including cooking-sensitive micronutrients.

2. The meal substitute according to claim 1, wherein the powder mixture for making the bread comprises at least the following ingredients:
wheat flour,
proteins,
vegetable oil,
fibers,
starch,
salt,
sodium pyrophosphate,
sodium bicarbonate,
BREAD flavor.

3. The meal substitute according to claim 2, wherein the powder mixture for making the bread comprises at least the following ingredients:
wheat flour,
soya bean protein isolate,
soya bean oil,
milk protein,
acacia fibers and wheat fibers,
manioc starch,
salt,
sodium pyrophosphate,
sodium bicarbonate,
BREAD flavor.

4. The meal substitute according to claim 3, wherein 100 g of powder mixture for making the bread comprises the following ingredients:
36 to 78 g of wheat flour,
14 to 34 g soya bean isolate,
3 to 8 g of soya bean oil,
2 to 6 g of milk protein,
1 to 5 g of acacia fibers and wheat fibers,
0.5 to 2 g of manioc starch,
0.3 to 0.9 g of salt,
0.35 to 0.9 g of sodium pyrophosphate,
0.2 to 0.55 g of sodium bicarbonate,
0.26 to 0.4 g of bread flavor.

5. The meal substitute according to claim 4, wherein 100 g of the powder mixture for making the bread consists of:
60.350 g of wheat flour,
23.871 g of soya bean protein isolate,
5.125 g of soya bean oil,
4.375 g of concentrated milk protein,
3.000 g of acacia fibers and wheat fibers,
1.250 g of manioc starch,
0.625 g of salt,
0.625 g of sodium pyrophosphate,
0.375 g of sodium bicarbonate,
0.325 g of bread flavor.

6. The meal substitute according to claim 5, wherein 100 g of the first powder mixture contains at least one of the following ingredients or their mixture: guarana, royal jelly, acerola and/or an enzyme preparation, according to amounts ranging from 0.05 g to 0.3 g.

7. The meal substitute according to claim 1, wherein the powder mixture for making the spread comprises at least:
vitamins,
minerals,
carbohydrates,
additives, and
components giving its flavor to the spread of the type: vegetables, fruit, chocolate, flavors.

8. The meal substitute according to claim 7, wherein 100 g of the powder mixture for making the spread consist of:
49 to 88 g of vegetables, fruits, chocolate, carbohydrates and additives,
0.15 to 0.35 g of vitamins,
10.25 to 25 g of minerals.

9. The meal substitute according to claim 8, wherein 100 g of the powder mixture for making the spread consists of:
0.239 g of vitamins,
18.04 g of minerals,
81.71 g of vegetables, fruit, chocolate, carbohydrates, flavors and additives.

10. The meal substitute according to claim 7, wherein the powder mixture for making the spread comprises, for providing minerals, at least by the following components:
tripotassium citrate,
anhydrous monocalcium phosphate,
magnesium carbonate,
tricalcium phosphate,
iron sulfate III,
zinc citrate,
manganese gluconate,
copper sulfate,
potassium iodide,
sodium selenite.

11. The meal substitute according to claim 10, wherein for 100 g of the powder mixture for making the spread, the provision of minerals is:
7.5 to 12.5 g of tripotassium citrate,
3 to 5 g of anhydrous monocalcium phosphate,
2 to 3.4 g of magnesium carbonate,
0.45 to 0.8 g of tricalcium phosphate,
0.09 to 0.15 g of iron sulfate III,
0.05 to 0.09 g of zinc citrate,
0.02 to 0.0375 g of manganese gluconate,
0.005 to 0.009 g of copper sulfate,
0.00028 to 0.0005 g of potassium iodide,
0.000175 to 0.0003 g of sodium selenite.

12. The meal substitute according claim 11, wherein for 100 g of the powder mixture for making the spread, the provision of minerals is:
10.250 g of tripotassium citrate,
4.225 g of anhydrous monocalcium phosphate,
2.718 g of magnesium carbonate,
0.625 g of tricalcium phosphate,
0.12 g of iron sulfate III,
0.072 g of zinc citrate,
0.03075 g of manganese gluconate,
0.00737 g of copper sulfate,
0.000375 g of potassium iodide,
0.000237 g of sodium selenite.

13. The meal substitute according to claim 7, wherein the powder mixture for making the spread comprises at least the following vitamins:
Ascorbic acid,
Vitamin E,
Nicotinamide,
Vitamin A,
Vitamin B5,
Vitamin D3,
Vitamin B6,
Vitamin B2,
Vitamin B1,
Vitamin B9,
Biotin,
Vitamin B12.

14. The meal substitute according to claim 13, wherein the powder mixture for making the spread comprises for 100 g of mixture, the following vitamins:
0.06 to 0.135 g of ascorbic acid,
0.04 to 0.09 g of vitamin E and its derivatives,
0.02 to 0.045 g of nicotinamide and of its derivatives
0.01 to 0.024 g of vitamin A and its derivatives,
0.008 to 0.019 g of vitamin B5 and its derivatives,
0.0025 to 0.006 g of vitamin D3 and its derivatives,
0.002 to 0.005 g of vitamin B6 and its derivatives,
0.0017 to 0.004 g of vitamin B2 and its derivatives,
0.0017 to 0.004 g of vitamin B1 and its derivatives,
0.00027 to 0.0006 g of vitamin B9 and its derivatives,
0.00006 to 0.00015 g of biotin and its derivatives,
0.000003 to 0.000007 g of vitamin B12 and its derivatives.

15. The meal substitute according to claim 14, wherein the powder mixture for making the spread comprises for 100 g of mixture, the following vitamins:
0.09633 g of ascorbic acid,
0.06505 g of vitamin E and its derivatives,
0.03315 g of nicotinamide and its derivatives,
0.01694 g of vitamin A and its derivatives,
0.01355 g of vitamin B5 and its derivatives,
0.00413 g of vitamin D3 and its derivatives,
0.00349 g of vitamin B6 and its derivatives,
0.002915 g of vitamin B2 and its derivatives,
0.002877 g of vitamin B1 and its derivatives,
0.000454 g of vitamin B9 and its derivatives,
0.000104 g of biotin and its derivatives,
0.000005 g of vitamin B12 and its derivatives.

16. The meal substitute according to claim 7, wherein the powder mixture, used as a salty spread, comprises at least one of the following ingredients: tomato powder, zucchini flakes, acacia fibers or grilled onion powder, green olives in pieces, carrot powder or celery powder.

17. The meal substitute according to claim 7, wherein the second powder mixture, used as a sweet spread, comprises at least one of the following ingredients: strawberry powder, raspberry powder, blueberry powder, beetroot coloring agent, strawberry flavor, raspberry flavor, blackberry flavor or dextrose.

18. The meal substitute according to claim 7, wherein it contains the following components:
Tripotassium citrate
Anhydrous monocalcium phosphate
Magnesium carbonate
Tricalcium phosphate
Iron sulfate III
Ascorbic acid
Zinc citrate
Vitamin E
Nicotinamide
Manganese gluconate
Vitamin A
Vitamin B5
Copper sulfate
Vitamin D3
Vitamin B6
Vitamin B2
Vitamin B1
Vitamin B9
Potassium Iodide
Sodium selenite
Biotin
Vitamin B12

19. The meal substitute according to claim 18, wherein for 100 g of the second powder mixture, it contains:
Tomato powder: 28.75 g
Zucchini flakes: 18.75 g
Acacia fibers: 10.498 g
Tripotassium citrate: 10.250 g
Grilled onion powder: 10 g
Anhydrous monocalcium phosphate: 4.225 g
Green olives in pieces: 3.125 g
Magnesium carbonate: 2.718 g
Guar gum: 1.875 g
Soya bean oil: 1.25 g
Dextrose: 1.25 g
Natural BASIL flavor: 1.25 g
Salt: 1.094 g
Xanthan gum: 1 g
Carrot powder: 1 g
Tricalcium phosphate: 0.625 g
Broth flavor: 0.625 g
Tomato-basil-garlic seasoning: 0.469 g
Acerola with 25% Vitamin C: 0.279 g
Maltodextrin: 0.209 g
Celery powder: 0.125 g
Iron sulfate III: 0.12 g
99% ascorbic acid: 0.09633 g
Ground grey pepper: 0.094 g
Zinc citrate: 0.07213 g
Ground oregano: 0.069 g
38.10% vitamin E: 0.06505 g
99.7% nicotinamide: 0.03315 g
Manganese gluconate: 0.03075 g
9.75% vitamin A acetate: 0.01694 g
91.6% vitamin B5: 0.01355 g
Copper sulfate: 0.007376 g
0.25% vitamin D3: 0.004128 g
82.8% vitamin B6: 0.00349 g
99.20% vitamin B2: 0.002915 g
78.98% vitamin B1: 0.002877 g
91.15% vitamin B9: 0.000454 g
Potassium iodide: 0.000375 g
Sodium selenite: 0.000237 g
99.40% biotin: 0.000104 g
97% vitamin B12: 0.000005 g

20. The meal substitute according to claim 18, wherein for 100 g of the second powder mixture it contains:
Dextrose: 21.524 g
Maltodextrin: 10.932 g
Tripotassium citrate: 10.250 g
Manioc starch: 9.383 g
Strawberry powder: 9.25 g
Concentrated milk protein: 6.25 g
Chicory inulin: 4.888 g
Anhydrous monocalcium phosphate: 4.225 g
Guar gum: 3.75 g
Beetroot coloring agent: 3 g
Strawberry flavor: 3 g
Raspberry flavor: 3 g
Magnesium carbonate: 2.718 g
Citric acid: 2.5 g
Mineral flavor masking: 1.375 g
Raspberry powder: 0.75 g
Tricalcium phosphate: 0.625 g
Xanthan gum: 0.625 g
Blackberry flavor: 0.375 g
Caramelized sugar: 0.363 g
Acerola with 25% vitamin C: 0.279 g
1% beta-carotene: 0.213 g
Blueberry powder: 0.125 g
Iron sulfate III: 0.12 g
99% ascorbic acid: 0.09633 g
Acesulfame K: 0.075 g
Zinc citrate: 0.07213 g
38.10% vitamin E: 0.06505 g
Sucralose: 0.056 g
99.7% nicotinamide: 0.03315 g
Manganese gluconate: 0.03075 g
9.75% vitamin A acetate: 0.01694 g
91.6% vitamin B5: 0.01355 g
Copper sulfate: 0.007376 g
0.25% vitamin D3: 0.004128 g
82.8% vitamin B6: 0.00349 g
99.20% vitamin B2: 0.002915 g
78.97% vitamin B1: 0.002877 g
91.15% vitamin B9: 0.000454 g
Potassium iodide: 0.000375 g
Sodium selenite: 0.000237 g
99.40% biotin: 0.000104 g
97% vitamin B12: 0.000005 g

21. A method for preparing a meal substitute of the bread and spread type as described in claim 1, wherein the bread is obtained by the following steps:
pour 48 g of the powder for making the bread into a container;
add 60 ml of water;
mix the obtained dough until a ball-shaped dough, a flat dough or any other shape is formed;
place the prepared form in a microwave oven;
bake for 2.5 to 6 mins at 750 W.

22. The method according to claim 21, wherein a glass at least partly filled with water is placed in the vicinity of the prepared form.

23. The method according to claim 21, wherein the spread is obtained by the following steps:
pour 45 ml of cold water into a container;
gradually add 16 g of the second powder mixture while stirring;
mix in order to obtain a homogeneous paste.
